(19) United States
(12) Patent Application Publication
(10) Pub. No.: US 2005/0180265 A1
(43) Pub. Date: Aug. 18, 2005

(54) Clockwork and watch provided with such a clockwork

(76) Inventor: Albert Van Selst, Waalwijk (NL)

Correspondence Address: GORDON & JACOBSON, P.C., 60 LONG RIDGE ROAD, SUITE 407, STAMFORD, CT, 06902, US

(21) Appl. No.: 10/509,540

(22) PCT Filed: Mar. 26, 2003
(86) PCT No.: PCT/EP03/50082

(30) Foreign Application Priority Data
Apr. 4, 2002 (NL) 1020299

(51) Int. Cl. G04B 19/22

(52) U.S. Cl. 368/21

(57) ABSTRACT

An apparatus for indicating time by means of a circular pointer movement over a dial includes a pointer arrangement having at least one first pointer and a second pointer. The at least one first pointer provides an indication of local time with a pointer period of revolution of twelve hours. The second pointer indicates a world time with a period of revolution of twenty-four hours by cooperation with a scale having a number of graduations which is a multiple of 24. A drive mechanism is coupled to the at least one first pointer and the second pointer, to cause the revolving movement of the at least one first pointer and the second pointer. Preferably, the at least one first pointer includes an “hour” hand with a period of revolution of twelve hours, a “minute” hand with a period of revolution of one hour, and a “second” hand with a period of revolution of one minute. In a preferred embodiment, the scale comprises 360 degrees or graduations. The apparatus may be constructed as part of a watch, but it may alternatively be used to advantage elsewhere, for example as part of a monitor screen of a PC, a mobile telephone, or an instrument panel in a car, train or airplane.

The invention relates to a clockwork comprising at least one first and a second pointer and designed for indicating a local time by means of a revolving pointer movement over a dial, wherein a pointer arrangement is present that comprises said at least one first pointer and indicates a local time with a slowest-pointer period of revolution of twelve hours and one or several further pointers coupled thereto for shorter periods of revolution, such as minute and/or second hands.

Such clockworks are generally known, various other indications being possible in addition to the standard local time.

The present inventor is aware of the fact that the rotation of the earth around its axis in fact represents a universal world time (Universal Time or UT) which can be derived from the Local Time (LT) with difficulty only; in particular, mistakes are readily possible such as in the case of appointments made between different time zones or at a change-over between summer time and winter time. World time may be represented in principle, for example, by Greenwich Mean Time (GMT). On the basis of the Greenwich meridian, the globe is divided into 24 parts (0 to 24 hours) of 15 degrees of longitude each, starting to count from the date line 180° opposite Greenwich.

The inventor has realized that there is a demand for a clockwork of otherwise standard construction on which this world time can be easily read without any further recalculation by means of an additional pointer and a suitably chosen scale.

It is accordingly an object of the present invention to provide such a clockwork, which in addition is easy to read, adjust, and manufacture.

According to the invention, a clockwork of the kind mentioned in the opening paragraph is for this purpose characterized in that said second pointer indicates a world time with a period of revolution of twenty-four hours in cooperation with a scale present on the clockwork of which the number of graduations is a multiple of twenty-four. Such a scale will preferably have a comparatively large number of graduations for reasons of reading accuracy. Suitable numbers are, for example, two hundred and forty graduations (=10×24) and seven hundred and twenty graduations (=30×24). A correlation with a corresponding multiple-of-twenty-four scale may be readily suggested in that the second pointer is given a suitable shape.

In a preferred embodiment, the dial division corresponding to a multiple of twenty-four comprises a scale of 360 graduations. Such a scale has major advantages. The time interval corresponding with one scale unit is four minutes, which is a particularly practical value. Such a scale, moreover, may be readily displayed next to a twelve-hour scale and possibly a twenty-four-hour scale. A practically useful scale thus remains possible in particular if the clockwork is constructed as a wrist watch and has the dimensions usual for this. An important additional advantage is that reading and—in as far as necessary—calculating are comparatively easy with such a scale because the users will be familiar with a duodecimal system anyway in the field of time measurements. In addition, a geometric correlation between “round the clock” and the 360 degrees of a circle is also attractive because of the watch user's familiarity with the notion and numerics of the geometric dimension of 360 degrees and (major) divisions thereof. Finally, a very important advantage of the clockwork according to the invention is that the 360-degree scale provides a direct and correct relation with the rotation of the globe, which in its turn fully defines the length of one day.

In a particularly favorable embodiment, said pointer arrangement can be adjusted to local time without thereby affecting the world time setting. Further aspects of the invention are recited in the dependent claims.

These and other features, aspects, and advantages of the invention will be explained in more detail below with reference to various embodiments and the accompanying Figures, in which:

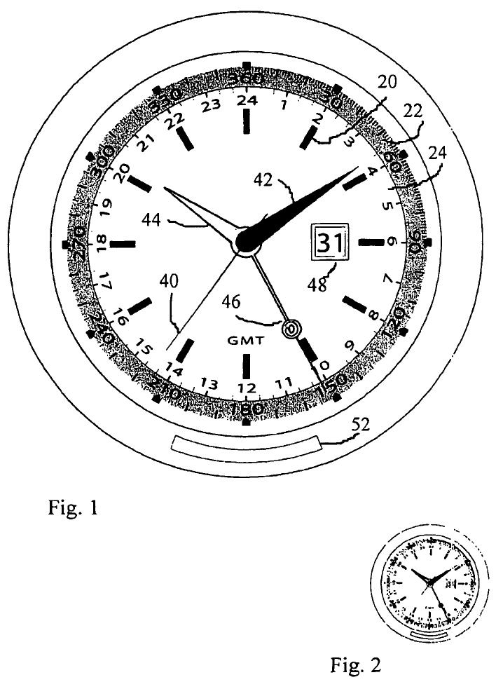

FIG. 1 shows a first preferred embodiment of the invention;

FIG. 2 pictures the embodiment of FIG. 1 at approximately its true size;

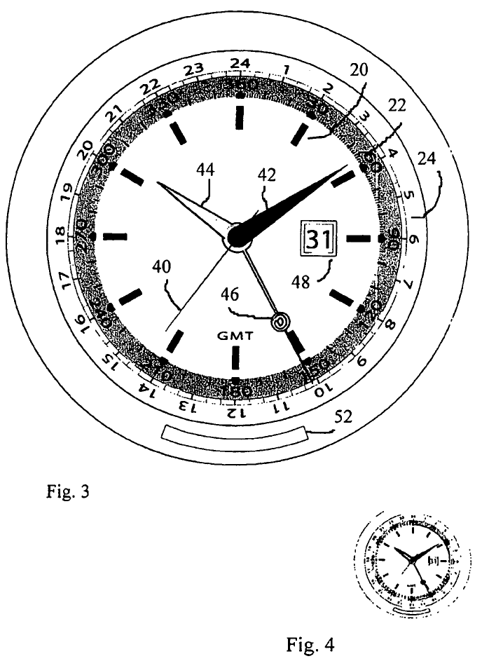

FIG. 3 shows a second preferred embodiment of the invention;

FIG. 4 pictures the embodiment of FIG. 3 at approximately its true size;

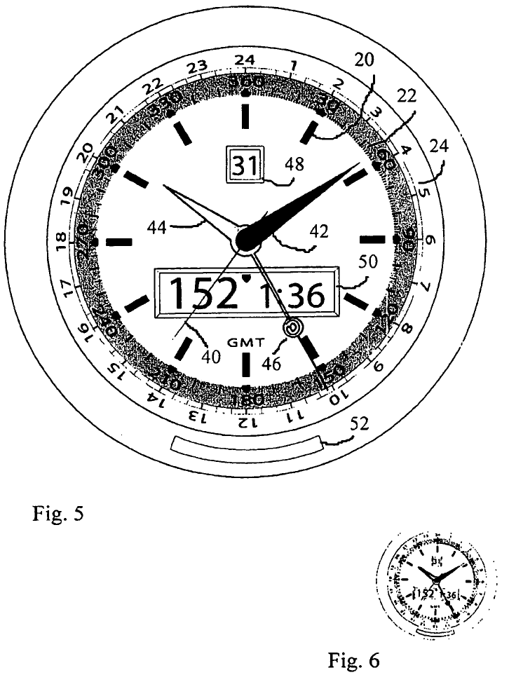

FIG. 5 shows a third preferred embodiment of the invention;

FIG. 6 pictures the embodiment of FIG. 5 at approximately its true size;

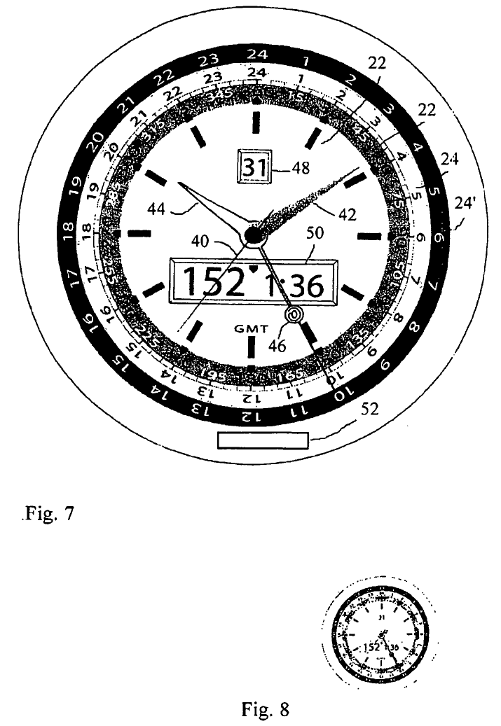

FIG. 7 shows a fourth preferred embodiment of the invention;

FIG. 8 pictures the embodiment of FIG. 7 at approximately its true size; and

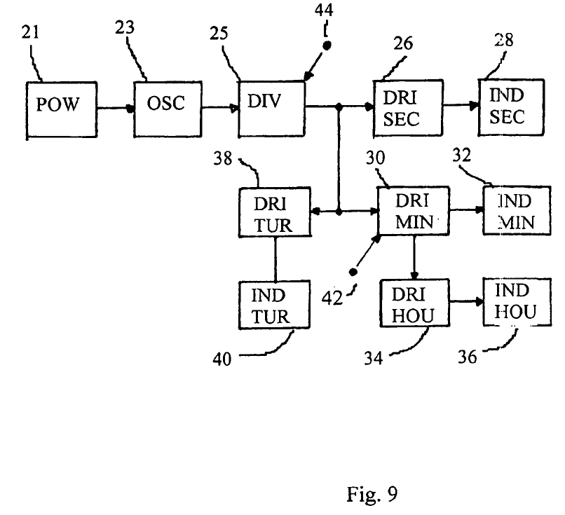

FIG. 9 is a block diagram of a drive mechanism for such a clockwork.

Except for FIGS. 2, 4, 6 and 8, the Figures are not drawn true to scale. Corresponding components have been given the same reference numerals in general.

In the ensuing description of the invention, a time indication denoted “Turntime” will be used as an international communication time, and the full rotation of the globe in one day is evenly divided into 360 turns, so that the time zones are divided into 15 turns per hour (I turn being 4 minutes), and a day from 0 to 24 hours is equal to 360 turns. Disregarding periodic and other small fluctuations in the speed of rotation of the earth, Turntime (TT) thus is the “real solar time” registered per 4-minute interval in the hour-minute-second system based on universal time (UT) from date line to date line and on Greenwich Mean Time (GMT).

Turntime is the same all over the world at all times; it knows no A.M., P.M., winter or summer time. This precludes mistakes in international communication, and in addition this Turntime corresponds to universal time (UT) and is accordingly also denoted Worldwide@Turntime.

Turntime watches or clocks are designed with one @pointer (Turntime) and furthermore in general with a second hand, a minute hand, and an hour hand for local time (LT), whether or not in combination with further indicators, such as a date window. In the preferred embodiment, the dial is provided with three scales: of 0 to 360 turns (TT), of 0 to 24 hours (UT), and of 1 to 12 hours (LT).

In a preferred embodiment, an additional digital counter with changing numerals for indicating 0 to 360 turns is used in combination with the analog or quasi-analog indication. This digital counter, whether or not in combination with the analog indication, registers the Turntime in turns (0 to 360), in minutes (0 to 4) and in seconds (0 to 60). This TMS (Turns, Minutes, Seconds) indication is very effective in international communications and makes mistakes in determining the correct time zone in fact impossible. A display example is as follows: 000/T 0/M 00/S. An international notation is as follows: @152/1.36; see in particular FIG. 4 discussed below.

FIG. 1 illustrates a first preferred embodiment of the invention, which is pictured at approximately its true size in FIG. 2. In this version there are four pointers 40, 42, 44, 46 for the seconds (40), the minutes (42), the hours (44), and the turns (46), respectively. The first three (40, 42, 44) form a pointer arrangement and are of more or less conventional design, with the second hand 40 thinner and/or in a different color, the minute hand 42 comparatively bold and long, and the hour hand 44 comparatively compact. The second hand may be omitted, if so desired. The pointer for the turns 46 has yet another shape and in this embodiment is longer than both the second hand 40 and the minute hand 42, has a width lying between those of said two hands 40 and 42, and is provided with a special sign, which is here chosen to be @. Alternative designs for this pointer 46 are equally conceivable in principle so as to distinguish it from the other three.

The clockwork is further provided with three fixedly arranged circumferential time scales 20, 22, 24. These are, from the center to the outside, first a standard division 20 of twelve hours showing no numerals, although the invention is not limited to this. Then there is a division 24 counting from 1 to 24 to indicate the passage of universal time. A further division into three parts is indicated in this case between every two numerals of the division 24, but an alternative division into four parts and the like is also useful. On the extreme outer side a scale 22 of 360 turns is indicated, the numerical value of the number of turns being indicated for every two hours of the universal time scale. This scale is further subdivided into turns (between 0 and 90 turns) and into multiples of 5 turns each time (for the remaining portion). The choice between these two manners of display may also be made differently, for example in graduations of two turns each, and it is also possible to provide the finer divisions over a different portion of the circumference, or not at all. Furthermore, a date window 48 is provided, and a legend 52 is applied in the rim of the clockwork, preferably reading “Worldwide@Turntime” as a characterizing, promotional text for a clockwork according to the invention. The clockwork may advantageously be additionally provided with further texts (not shown in the drawing), for example for advertising purposes. It is also possible to display the name or logo of a company, in particular if the clockwork in question is (also) used as a business gift. In addition it is noted that in an attractive modification, two date windows 48 may be provided, one for the turn date and one for the local date. The latter may be positioned as shown in FIG. 1, whereas the former is positioned in the central part e.g. below the numbers 360, 24 and 1 on scales 22, 24 and 20 respectively. The turn date changes if the turn time pointer 46 crosses 360 on scale 22.

FIG. 2 pictures the embodiment of FIG. 1 at approximately the true size for a watch, for example a wrist watch. Otherwise, there are no differences with FIG. 1. This Figure already gives a good idea of the practical applicability of the present invention. These aspects can obviously be best judged and appreciated from a prototype.

FIG. 3 shows a second preferred embodiment of the invention. FIG. 4 shows this embodiment at approximately its true size. The two outer scales 22, 24 of FIG. 1 have changed position here. The outer scale 24 has been provided as a ring with rotation possibility, such that the standard position as shown can be secured by means of a click mechanism. This click mechanism is preferably provided for every hourly and halve-hourly position. In this way the scale can be positioned in accordance with the time difference of any geographical position. There are no further differences with FIG. 1. The arrangement of a rotary ring at the outer circumference of the clockwork has major practical advantages.

FIG. 5 shows a third preferred embodiment of the invention. FIG. 6 again shows this at approximately its real-life size. A digital display with changing numerals is now included for the world time expressed in turns, in this case 152 1:36, indicating the number of turns (152, see also the pointer position for the turns), and 1 minute 36 seconds (the time elapsed after the exact moment of reaching 152 turns). This latter display preferably has a cycle time of 4 clock minutes or 1 turn. Otherwise, there are no differences with FIG. 3.

FIG. 7 shows a fourth preferred embodiment of the invention. FIG. 8 again shows this at approximately its real-life size. In this embodiment there are two 24 hours scales 24,24′ that have been provided with rotation possibility and a suitable click mechanism. These may be used for the time differences of two locations, e.g. the locations of departure and arrival on traveling. For greater clarity the second scale 24′ is a negative image of the first scale 24. A further difference with the third embodiment is that the turn scale 22 is provided with additional markers at 15, 45, 75 . . . and 345 turns. The corresponding values are also included in the scale, although in white in stead of black as for the values 30, 60 . . . and so on. Otherwise, there are no differences with FIG. 5.

FIG. 9 is a diagram illustrating a drive mechanism for a clockwork according to the invention. Block 21 represents a power supply, which may be a conventional one such as a battery, solar cells, or an automatic mechanical winding mechanism. The first-mentioned option is supposed to be present here for simplicity's sake. The power drives an oscillator 23 which supplies a stable oscillation of high frequency. A divider 25 divides this frequency by a suitable factor so as to form the seconds pulse. The seconds pulse is applied to the seconds driver 26, whereby the second hand symbolized by block 28 is moved. The minute hand 32 is moved in a similar manner, possibly by means of a further division (not indicated in any more detail for simplicity's sake) of the seconds frequency and the minutes driver 30. The user can adjust the minute hand by means of a mechanical device 42, for example when passing the boundary between two time zones.

The hour hand 36 is moved in a similar manner, possibly by means of a further division (not indicated in any more detail for simplicity's sake) of the seconds frequency and the hours driver 34. When the minute hand is adjusted by means of the device 42, the hour hand is moved at the same time in a manner that is generally known, for example by a gear transmission. The device 42 may alternatively be electronically operated. In that case the minutes or fractions thereof may be adjusted by means of suitable pulses. The position of the pointer 46 for the turns, however, remains unchanged during this; see below.

The turns pointer 46 is moved in a similar manner as above, possibly by means of a further division (not indicated in any more detail for simplicity's sake) of the seconds frequency and the turns driver 38. Said pointer 46 is accordingly not moved when the device 42 is operated. The device 42 suffices for adjusting certain clockworks in which the risk of reading errors of appreciable size can be disregarded, because minor errors in the time indication need not be considered.

It may nevertheless be necessary in certain cases to correct the minor errors mentioned above and other errors, for example when the battery is exhausted and is to be replaced. In that case an additional device 44 may be present, such as directly at the output of the divider 24, for adjusting the position of the turns pointer 46 as well as of the minute and hour hands. An alternative solution is to provide a separate mechanism for exclusively adjusting the turns pointer.

The invention was described above with reference to preferred embodiments shown in the drawings. Those skilled in the art will readily conceive various modifications thereto, and accordingly the invention should not be regarded as limited to the preferred embodiments. Rather, an extent of the invention should be considered in the light of the scope of the claims listed hereinafter. Thus in particular an entirely mechanical realization of the invention will also fall within the scope of these claims.

A clockwork according to the invention may be implemented not only in a watch, but advantageously also as a clock on a monitor screen of a PC (Personal Computer) or a mobile telephone, and in particular in a dashboard or instrument panel of a car, train, or airplane.

1. An apparatus for indicating time comprising:
a pointer arrangement including at least one first pointer and a second pointer, the at least one first pointer providing an indication of local time by means of revolving movement over a dial with a pointer period of revolution of twelve hours, the second pointer providing an indication of a world time by means of revolving movement over the dial with a period of revolution of twenty-four hours in cooperation with a first scale present on the dial having a number of graduations that is a multiple of 24; and
a drive mechanism, coupled to said at least one first pointer and said second pointer, which is adapted to cause the revolving movement of said at least one first pointer and said second pointer.

2. An apparatus as claimed in claim 1, wherein said first scale has 360 degrees, each degree corresponding to a time interval of four minutes.

3. An apparatus as claimed in claim 1, wherein said at least one first pointer is independently adjustable with respect to said second pointer so as to set a time that differs in dependence on location, while said second pointer continues to indicate world time.

4. An apparatus as claimed in claim 2, wherein said at least one first pointer a comprises three pointers.

5. An apparatus as claimed in claim 1, provided with a second scale corresponding to an interval of twelve hours, a third scale corresponding to an interval of twenty-four hours, and wherein said first scale is divided into 360 units.

6. An apparatus as claimed in claim 5, wherein said first, second and third scales are arranged in a fixed position.

7. An apparatus as claimed in claim 5, wherein said third scale is constructed as an adjustable rotary ring, and said first and second scales are fixedly positioned and are present within said third scale.

8. An apparatus as claimed in claim 1, further provided with a time indication in the form of a block with changing numerals associated with said second pointer.

9. An apparatus as claimed in claim 1, further provided with a clock face having a visible portion with a legend.

10. A watch provided with said apparatus as claimed in claim 1.

11. An apparatus as claimed in claim 1, wherein said at least one first pointer includes a slowest pointer with a period of revolution of twelve hours and at least one faster pointer with a period of revolution less than twelve hours.

12. An apparatus as claimed in claim 11, wherein said at least one faster pointer includes a pointer with a period of revolution of one hour and another pointer with a period of revolution of one minute.

13. An electronic appliance provided with said apparatus as claimed in claim 1.

14. An electronic appliance as claimed in claim 13 as part of a personal computer system.

15. An electronic appliance as claimed in claim 13 as part of a mobile telephone.

16. An electronic appliance as claimed in claim 13 as part of an instrument panel in a car, train or airplane.
